(19) United States
(12) Patent Application Publication
(10) Pub. No.: US 2008/0173832 A1
(43) Pub. Date: Jul. 24, 2008

(54) Valuable paper validator

(75) Inventors: Tien-Yuan Chien, Taipei City (TW); Wei-Jr Chen, Taipei City (TW); Hai-En Tsai, Taipei City (TW); Wen-Yuan Tsai, Taipei Hsien (TW); Cheng-Yi Lin, Taipei City (TW); Ya-Huei Yang, Taitung Hsien (TW)

Correspondence Address: BIRCH STEWART KOLASCH & BIRCH, PO BOX 747, FALLS CHURCH, VA, 22040-0747, US

(73) Assignee: INTERNATIONAL CURRENCY TECHNOLOGIES CORPORATION

(21) Appl. No.: 11/657,097

(22) Filed: Jan. 24, 2007

(51) Int. Cl. G06K 9/58; G06K 9/74

(52) U.S. Cl. 250/556; 356/71

(57) ABSTRACT

A valuable paper validator for use in a vending (coin change) machine is disclosed to include a delivery unit for delivering a valuable paper through a delivery path, a LED package having multiple LED chips spaced above the delivery path and controllable to emit different wavelengths of intense pulsed light, a collimator lens for collimating light passing from the LED package through the valuable paper, a photodiode spaced below the delivery path for collecting light passed through the valuable paper for verifying the authenticity of the valuable paper, and a condensing lens for focusing different wavelengths of light passed through the valuable paper onto the photodiode.

### BACKGROUND OF THE INVENTION

1. Field of the Invention

The present invention relates to a valuable paper validator practical for use in a vending machine or coin change machine and more particularly, to such a high-accuracy valuable paper validator, which uses a LED package to emit different wavelengths of intense pulsed light through the valuable paper, a collimator lens to collimate different wavelengths of intense pulsed light onto a test zone of the valuable paper, and a photodiode to collect light passed through the valuable paper for comparing to a predetermined reference value by an internal microcontroller of the valuable paper validator to verify the authenticity of the valuable paper.

2. Description of the Related Art

Following fast development of technology, our mode of living has been changed. Various automatic vending machines (card dispensers, ticket venders, coin change machines, etc.) are used everywhere to sell different products without serviceman. These automatic vending machines save much labor and bring convenience to people. The coin changer of a vending machine accepts coins and paper money.

However, venders and consumers are always assailed by the problem of counterfeit money since the use of paper currency. Following development of computer technology, evil persons may use a computer to scan, copy and print paper money. Therefore, a paper currency has anti-counterfeiting techniques. Visible anti-counterfeiting techniques of paper currency include paper material, ink, seal, mark and etc. that can easily be verified with the eyes. However, examining invisible anti-counterfeiting techniques requires a special machine or instrument to verity the authenticity. A validator for this purpose uses rollers to carry in the inserted paper currency over a magnetic head, which detects the magnetic inks of the emblems and portrait and compares the detected signal with respective predetermined reference values for determining the authenticity of the paper current subject to the comparison result. However, the magnetic head tends to be contaminated by ink dirt, resulting in an inaccurate detection. Further, a counterfeit currency maker may make a counterfeit currency that carrying similar magnetic inks to cheat the machine.

Nowadays, modern valuable paper validators commonly use different LEDs (light emitting diodes) to emit different light for examining the characteristics of different paper currency. FIGS. 11 and 12 show a prior art valuable paper (bill) validator. This design of valuable paper validator comprises a first linear light source A1 and a second linear light source A2 obliquely disposed at two sides above a test zone F1, a plurality of photo sensors C1 set between the two linear light sources A1 and A2, and a first optical element B1 set below the photo sensors C1. When a document (valuable paper) E1 enters an inlet of the valuable paper validator, the inlet is blocked, and a sheet-transferring roller set is started to carry the document (valuable paper) E1 through the test zone F1. At the same time the linear light sources A1 and A2 are controlled to emit pulsed light onto the document (valuable paper) E1, the first optical element B1 condenses reflected light onto the photo sensors C1, and the photo sensors C1 feedback the detected value at a predetermined circulation time point. This detected value is indicative of the average PPF (paired-pulse facilitation) of the scanned surface color of the document (valuable paper) E1. The aforesaid method is to examine the whole document (valuable paper) E1. Further, a supplementary light source A4 and a fourth optical element B4 may be provided at the other side. The supplementary light source A4 is controlled to emit penetrative light that passes through the document (valuable paper) E1 for checking the transmission of the document (valuable paper) E1. After scanning, an operating unit of the valuable paper validator receives different values produced by different light sources and compares the values to storage reference values, thereby determining to accept or reject the document (valuable paper) E1. According to this induction method, it is necessary to verify multiple strip blocks of the document (valuable paper) E1 and to compare the scanned values produced by the strip blocks to reference values for further determination. According to this design, each linear light source A1 or A2 uses different colors of light emitting diodes (LEDs) A3 to emit different colors of light for verification. Further, a second optical element B2 and a third optical element B3 are set in front of the first linear light source A1 and the second linear light source A2 to correct the respective light source output angle. The arrangement of the linear light sources A1 and A2, the optical elements B1, B2 and B3 and the photo sensors C1 must be carefully calculated so that detected signals can be compared to reference values for further accurate determination.

The aforesaid prior art valuable paper validator has numerous drawbacks as outlined hereinafter.
1. Because the LEDs A3 in each linear light source A1 or A2 are spaced from one another at a distance, these LEDs A3 do not allow the document (valuable paper) E1 to be examined at one same test zone F1 with different colors of light, and can only use the average value of all scanned light to calculate the surface color reaction of the document (valuable paper) E1.
2. Different documents (valuable paper) E1 from different countries have different anti-counterfeiting characteristics. Therefore, the main unit must provide a high capacity database for storing predetermined reference data for comparison.
3. This validation method uses the light emitting diodes A3 to emit different colors of light onto the document (valuable paper) E1, and the photo sensors C1 with the first optical element B1 to collect reflected light from different strip blocks of the document (valuable paper) E1 for comparing to reference values. The precision of the adjustment between the light emitting diodes A3, the photo sensors C1 and the optical elements B1, B2, and B3 is critical.
4. After scanning of different strip blocks of the document (valuable paper) E1 with different colors of light from the light emitting diodes A3, a precision array computing procedure is necessary to verify the authenticity of the document (valuable paper) E1. This computing procedure requires a certain length of time, not suitable for use in a vending machine to verify the authenticity of a paper money.
5. The complicated structure of this design of valuable paper validator uses so many parts, resulting in a high manufacturing cost.

Further, ATMs (Auto Teller Machines) or bill counters used in a banking system commonly use ultraviolet lamps to scan paper currency. Ultraviolet lamps are not suitable for use in a bill validator for vending machine. When an ultraviolet lamp type bill validator is used in an outdoor vending machine, air moisture may pass through gap between the lamp bulb and the electric socket, causing a short circuit. Further, the bulb of an ultraviolet lamp attenuates quickly with use. Further, an ultraviolet lamp consumes much electric power and releases much heat energy during operation. Further, an ultraviolet lamp has a big side and a short working life, and is easy to break.

Therefore, it is desirable to provide a valuable paper validator that eliminates the aforesaid problems.

### SUMMARY OF THE INVENTION

The present invention has been accomplished under the circumstances in view. It is one object of the present invention to provide a valuable paper validator for vending machine or coin change machine, which uses one LED package to emit different wavelengths of intense pulsed light onto one same location at the test valuable paper, and one corresponding photodiode to receive light passing through the test valuable paper for verifying the authenticity of the test valuable paper. This arrangement eliminates the complicated valuable paper validation procedure of the prior art design of using multiple LEDs and photo sensors. Therefore, the invention requires less installation space in the vending machine or coin change machine, and saves much the installation cost.

It is another object of the present invention to provide a valuable paper validator, which uses one LED package, one collimator lens, one condensing lens and one photodiode to constitute the valuable paper validation unit for verifying the authenticity of valuable papers accurately. This design has a simple structure that eliminates the drawbacks of the complicated prior art design of using multiple light emitting diodes to scan different test zones of the test valuable paper and multiple optical elements to correct the light source output angle and an optical element to gather scanned light onto the photo sensor. Further, the design of the valuable paper validator of the invention has the advantages of. non-necessity of lamp warming time, fast reaction speed, small size, low power consumption, low pollution, high brightness and long working life.

### BRIEF DESCRIPTION OF THE DRAWINGS

FIG. 1 is a sectional side view of a valuable paper validator according to the present invention.

FIG. 2 is a system block diagram of the valuable paper validator according to the present invention.

FIG. 3 is a valuable paper validation operation flow of the valuable paper validator according to the present invention.

FIG. 4 is a schematic drawing illustrating a valuable paper validation action of the valuable paper validator according to the present invention.

FIG. 4A is a schematic drawing illustrating the output optical field according to the present invention.

FIG. 4B illustrates the light intensity distribution of the output optical field according to the present invention.

FIG. 4C is a schematic drawing illustrating a valuable paper validation action of an alternate form of the valuable paper validator according to the present invention.

FIG. 5 is a circuit diagram of the LED package of the valuable paper validator according to the present invention (I).

FIG. 6 is a circuit diagram of the LED package of the valuable paper validator according to the present invention (II).

FIG. 7 is a circuit diagram of the LED package of the valuable paper validator according to the present invention (III).

FIG. 8 is a circuit diagram of the digital/analog converter of the valuable paper validator according to the present invention.

FIG. 9 is a circuit diagram of the photodiode of the valuable paper validator according to the present invention.

FIG. 10 is a circuit diagram of the amplifier of the valuable paper validator according to the present invention.

FIG. 11 is a schematic drawing of a valuable paper validator according to the prior art.

FIG. 12 is a schematic drawing illustrating the distribution of the linear light source according to the prior art.

### DETAILED DESCRIPTION OF THE PREFERRED EMBODIMENT

Before explanation of the features of the present invention, it is necessary to understand the physical characteristics of light. The colors of known light rays include red, orange, yellow, green, blue, indigo and purple. Different colors of light rays have different wavelengths. When emitting different colors of light rays onto an object, different transmission and refractive indexes will be obtained. For example, when emitting light onto a red color object, the red color object will reflect red color of light and absorb other colors of light, and therefore only red color of light is seen. When emitting different colors of light onto an object, the light intensity of other colors of light that passed through the object will be weaker than the red color of light because red color of light has the highest transmission. The invention uses the aforesaid physical characteristics of light in verification of valuable paper. Further, because different wavelengths of light have different colors, the following description of the present invention uses wavelengths for explanation.

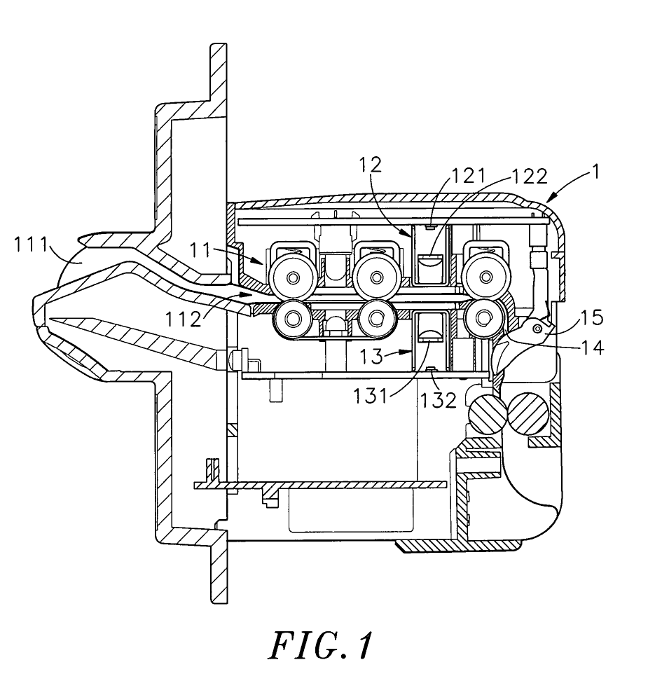

Referring to FIG. 1, a valuable paper validator 1 in accordance with the present invention is shown comprising a delivery unit 11, a validation unit formed of an optical emitter module 12 and an optical receiver module 13, a security gate 14 and a security hook 15.

The delivery unit 11 has an insertion slot 111 through which a valuable paper is inserted, and a delivery path 112 in communication with the insertion slot 111.

The optical emitter module 12 is provided above the delivery path 112, comprising a LED package 121, which has multiple light emitting diode chips controllable to emit different wavelengths of light, and a collimator lens 122 that guides light rays from the LED package 121 across the delivery path 112.

The optical receiver module 13 is provided beneath the delivery path 112, comprising a condensing lens 131 adapted to condense light passing from the LED package 121 through the collimator lens 122 onto a valuable paper being delivered through the delivery path 112, and a photodiode 132 adapted to receive light passing through the condensing lens 131.

The security gate 14 is provided at the rear end of the delivery path 112. The security hook 15 is provided at one side of the security gate 14. The security gate 14 and the security hook 15 constitute a security mechanism.

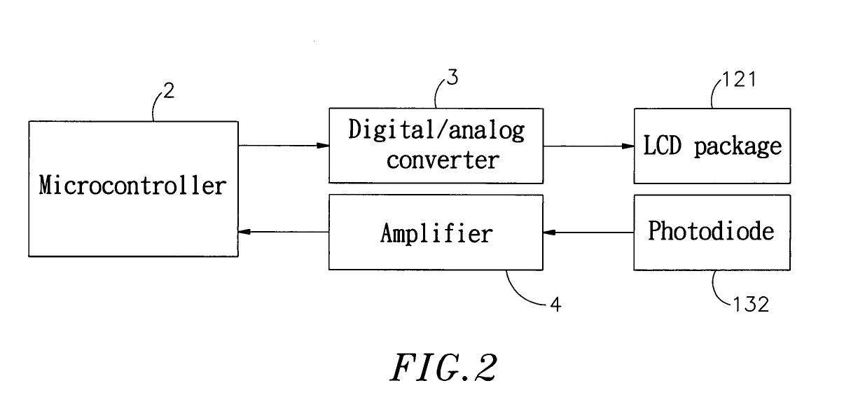

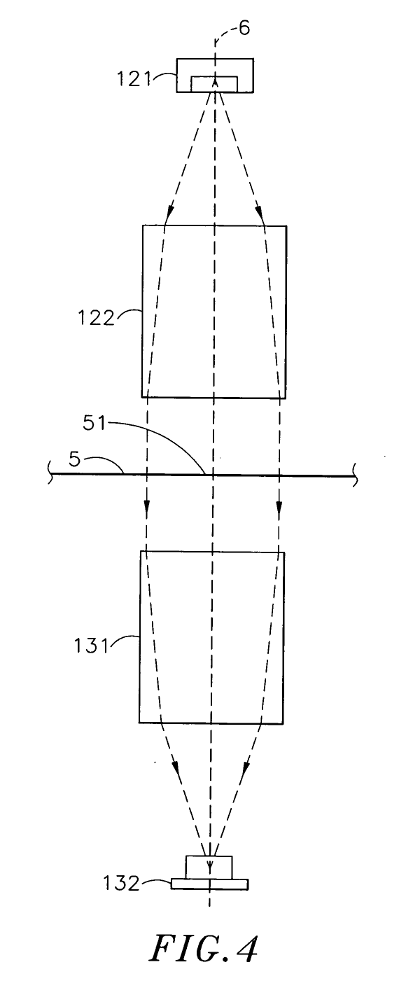

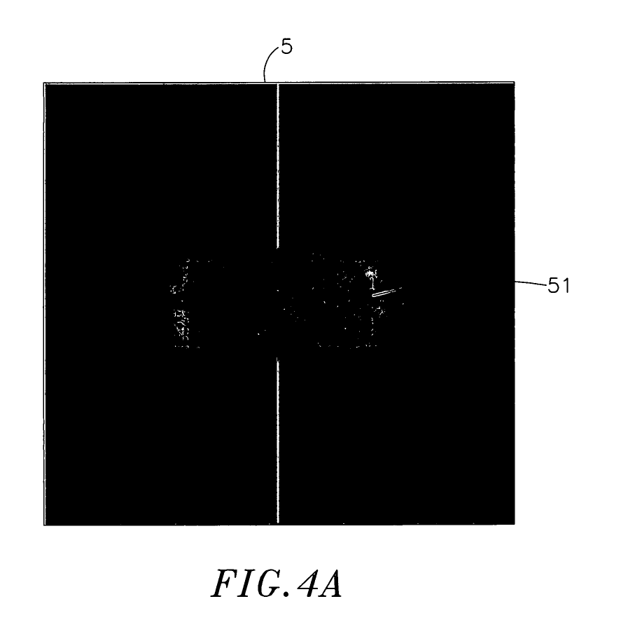

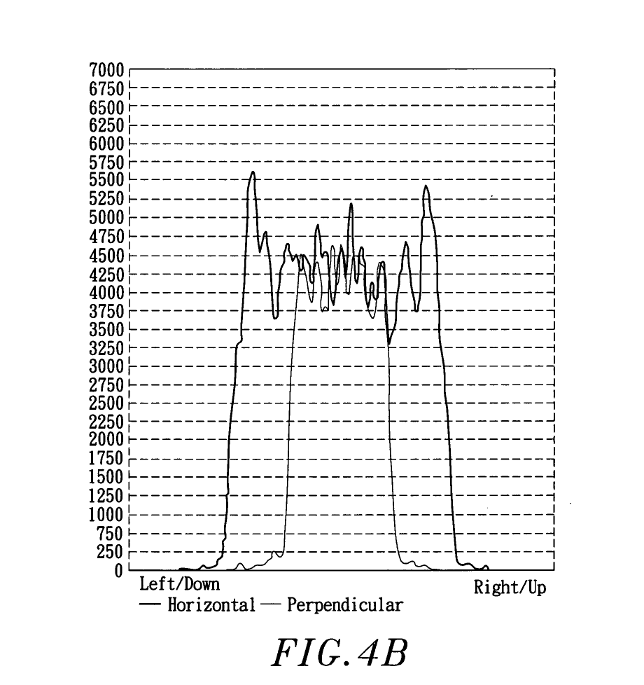

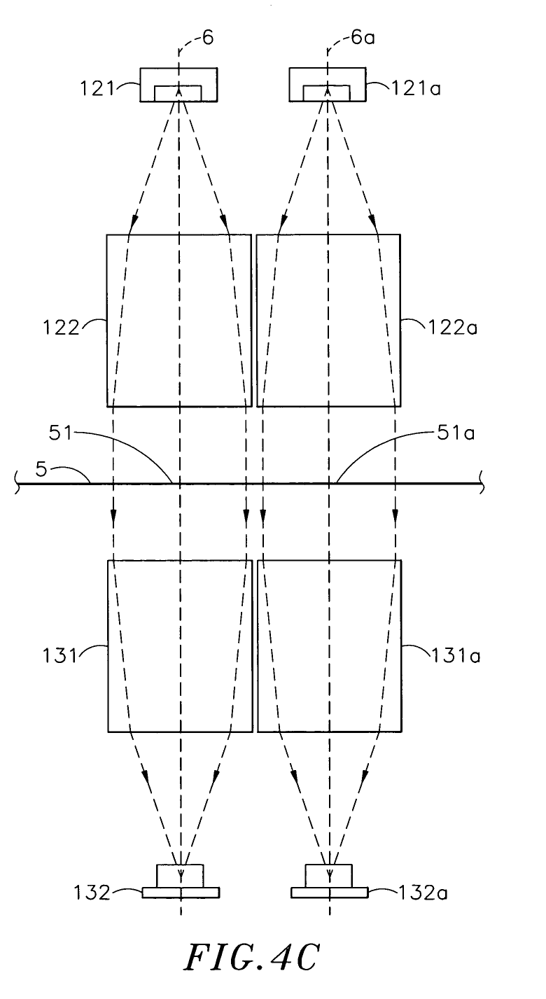

Referring to FIGS. 2 and 4 and FIG. 1 again, the valuable paper validator 1 may be used in a vending machine or coin change machine. When a valuable paper 5 is inserted into the insertion slot 111, it is delivered through the delivery path 112 by the delivery unit 11 (because the delivery unit 11 is of the known art and not within the scope of the present invention, no further detailed description in this regard is necessary). At this time, an internal microcontroller 2 of the valuable paper validator 1 outputs a digital start signal to a digital/analog converter 3, which converts the digital start signal into an analog start signal and sends the analog start signal to the LED package 121 of the optical emitter module 12, causing the LED package 121 to emit different wavelengths of intense pulsed light toward the collimator lens 122. When the intense pulsed light goes from the LED package 121 through the collimator lens 122, the collimator lens 122 collimates the intense pulsed light into a collimated light beam that goes through a predetermined area and shape of test zone 51 of the valuable paper 5 (seed FIGS. 4 and 4A). After passed through the test zone 51 of the valuable paper 5, the collimated light beam goes to the condensing lens 131 and is then condensed by the condensing lens 131 onto the photodiode 132, which is induced to output a signal to an amplifier 4 for amplification. The amplifier 4 then sends the amplified signal to the microcontroller 2. The output pattern and intensity distribution of the signal are simulated in FIGS. 4A and 4B, i.e., FIG. 4A is a schematic drawing illustrating the output optical field, and FIG. 4B illustrates the light intensity distribution of the output optical field. Upon receipt of the amplified signal from the amplifier 4, the microcontroller 2 compares the light intensity distribution of the signal to a predetermined reference value, thereby determining the authenticity of the valuable paper 5 subject to the comparison result.

Referring to FIG. 4C, the valuable paper validator 1 can be made having multiple validation units arranged in parallel for checking the characteristics of different test zones 51 and 51a of the inserted valuable paper 5. The LED package 121 or 121a, the collimator lens 122 or 122a, the condensing lens 131 or 131a, and the photodiode 132 or 132a of each validation unit are kept in a linear relationship relative to the corresponding test zone 51 or 51a of the valuable paper 5, i.e., the parts of each validation unit are on a same axis 6 or 6a. Because the validation units are arranged in parallel and because the LED package 121 or 121a, the collimator lens 122 or 122a, the condensing lens 131 or 131a, and the photodiode 132 or 132a of each validation unit are axially aligned in line, different test zones 51 and 51a of the inserted valuable paper 5 will not be detected twice, and the intense pulsed light from one validation unit will not be interfered with the intense pulsed light from the adjacent validation unit.

However, there are two ways to verify the authenticity of the valuable paper 5. One way is to check the paper quality of the valuable paper 5, i.e., the LED package 121 of the optical emitter module 12 is controlled to emit different wavelengths of light through the collimator lens 122 and the test zone 51 of the valuable paper 5, causing the test zone 51 to produce different transmittance, therefore the photodiode 132 obtains different intensity of light source from the test zone 51 through the condensing lens 131 for comparing to the predetermined reference value by the microcontroller 2 so that the comparison result is used to determine the authenticity of the valuable paper 5. The other way is to use the color of the pattern on the valuable paper 5 to filter different wavelengths of light from the LED package 121, for enabling the filtered light signal to be further compared to the predetermined reference value by the microcontroller 2 so that the microcontroller 2 determines the valuable paper 5 to be true or false subject to the comparison result.

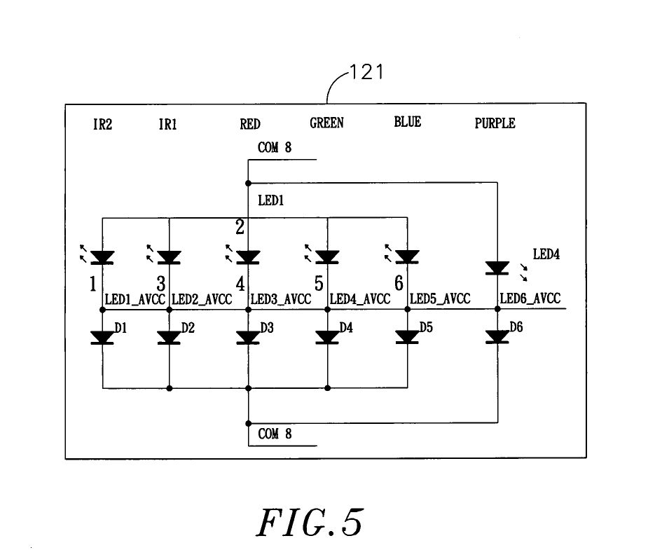

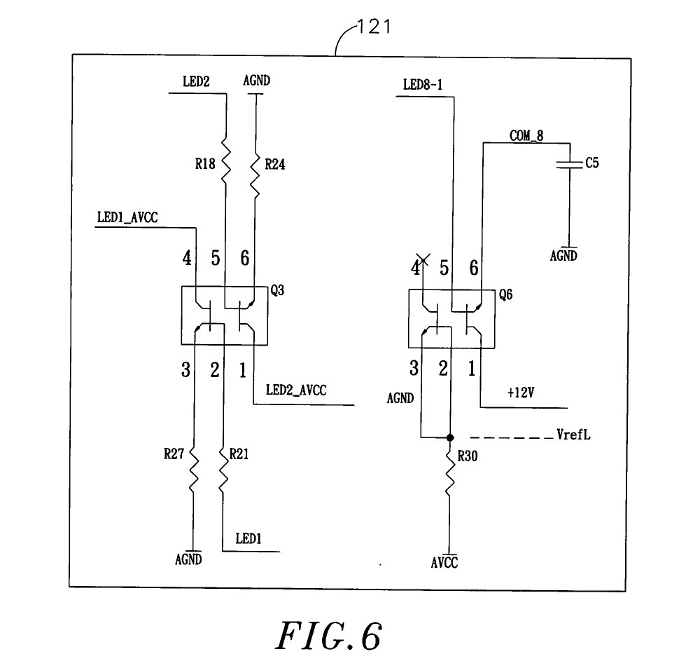

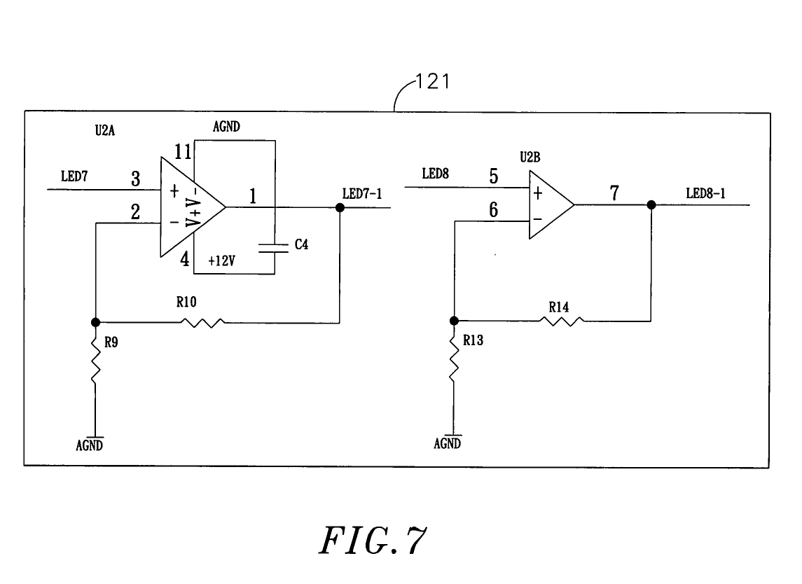

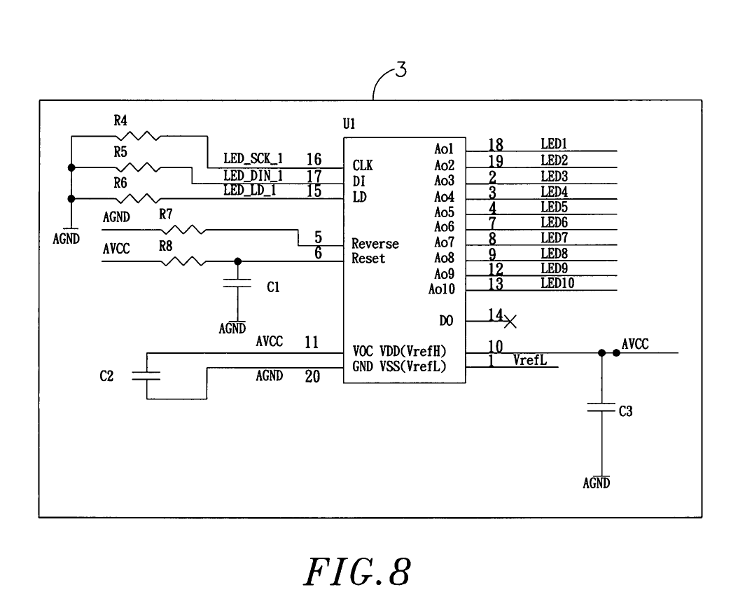

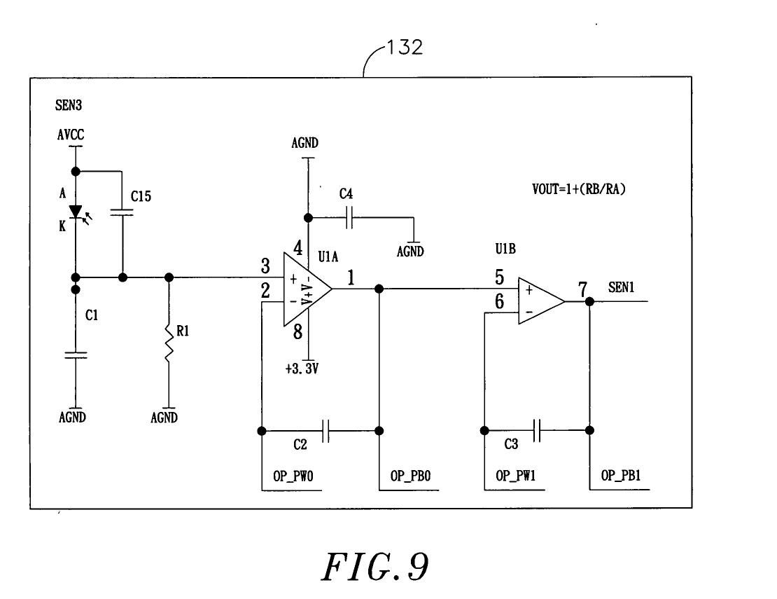

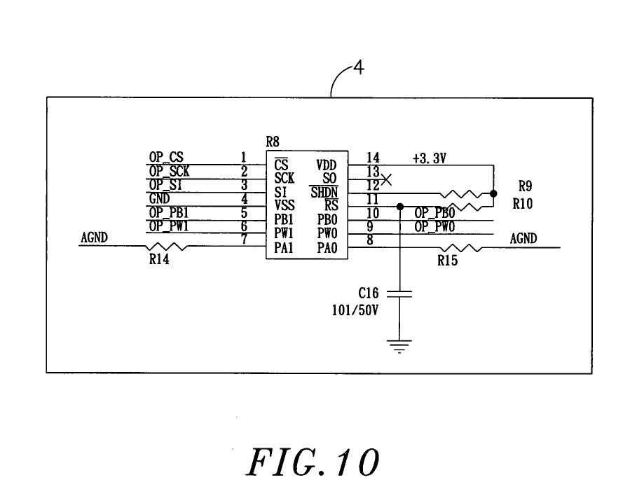

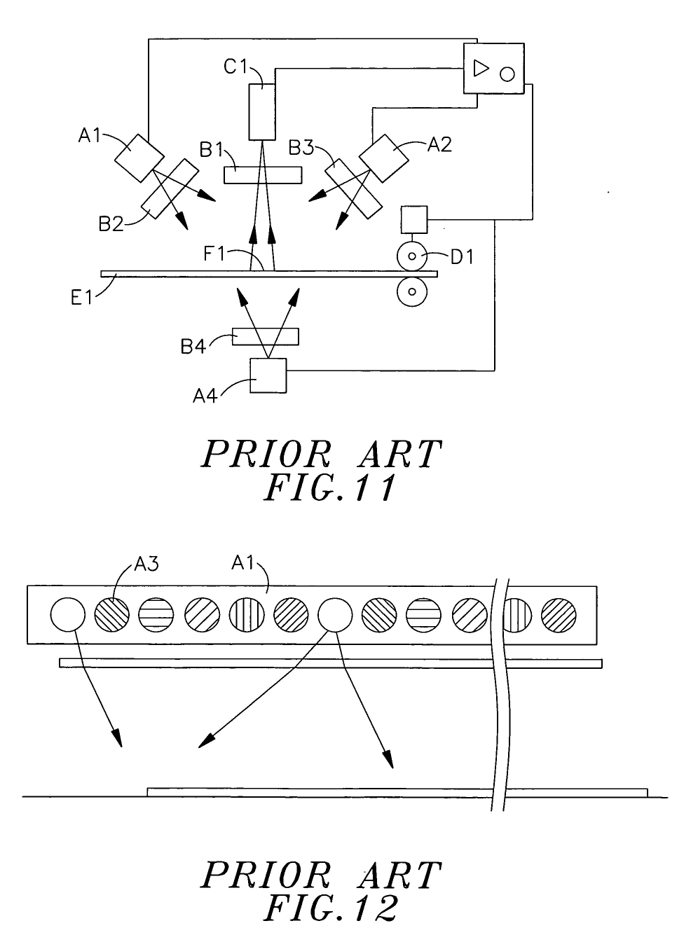

FIGS. 5˜7 illustrates the circuit diagram of the LED package 121 of the optical emitter module 12. FIG. 8 illustrates the circuit diagram of the digital/analog converter 3. FIG. 9 illustrates the circuit diagram of the photodiode 132 of the optical receiver module 13. FIG. 10 illustrates the circuit diagram of the amplifier 4.

As indicated above, the invention is to verify the authenticity of a valuable paper 5 by driving the internal light emitting diode chips of the LED package 121 to emit different wavelengths of intense pulsed light through the collimator lens 122 onto a same location at the valuable paper 5. This design needs not to use multiple LEDs and related optical elements to correct light source output angle. Therefore, the invention greatly saves the cost and improves the validation accuracy. The use of the LED package 121 to emit different wavelengths of intense pulsed light has the advantages of non-necessity of lamp warming time, fast reaction speed, small size, low power consumption, low pollution, high brightness and long working life. For the aforesaid advantages, the invention is practical for use in the limited space of a vending machine or coin change machine. By means of the validation of the valuable paper validator of the present invention, valuable paper verification efficiency and accuracy are greatly improved.

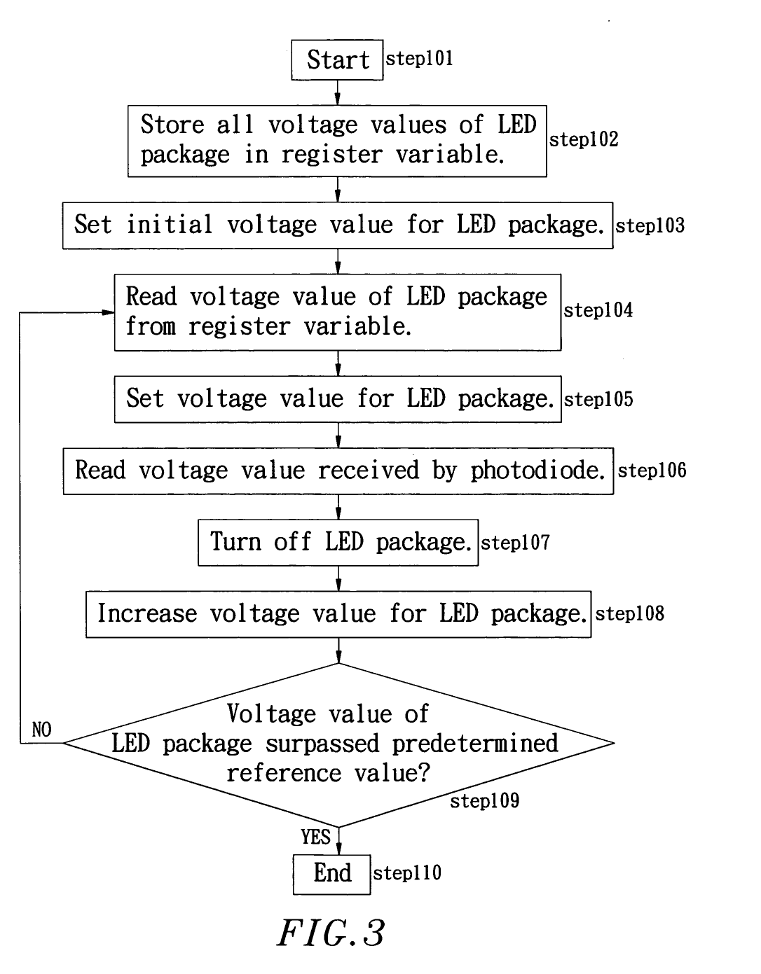

Referring to FIGS. 3 and 4, the valuable paper validation operation of the valuable paper validator includes the steps of:

(101) Start;

(102) Store all voltage values of the LED package 121 in a register variable;

(103) Set an initial voltage value for the LED package 121;

(104) Read the voltage value of the LED package 121 from the register variable;

(105) Set a voltage value for the LED package 121;

(106) Read a voltage value received by the photodiode 132;

(107) Turn off the LED package 121;

(108) Increase the voltage value for the LED package 121;

(109) Determine whether or not the voltage value of the LED package 121 surpasses the predetermined reference value? Return to step (104) when negative; and

(110) End.

To have the LED package 121 emit different wavelengths of intense pulsed light, the LED package 121 can be made having five light emitting diode chips encapsulated therein for emitting different wavelengths of intense pulsed light. These light emitting diode chips include a first light emitting diode chip that emits 615 nm˜635 nm red light, a second light emitting diode chip that emits 515 nm˜532 nm green light, a third light emitting diode chip that emits 460 nm˜475 nm blue light, a fourth light emitting diode chip that emits 850 nm infrared light and a fifth light emitting diode chip that emits 940 nm infrared (or ultraviolet) light.

As indicated above, the invention provides a valuable paper validator, which has the following features:

1. The valuable paper validator of the present invention uses one LED package to emit different wavelengths of intense pulsed light onto one same location at the test valuable paper, and one corresponding photodiode to receive light passing through the test valuable paper for verifying the authenticity of the test valuable paper. This arrangement eliminates the complicated valuable paper validation procedure of the prior art design of using multiple LEDs and photo sensors. Therefore, the invention requires less installation space in the vending machine or coin change machine, and saves much the installation cost.

2. The invention uses one LED package, one collimator lens, one condensing lens and one photodiode to constitute the valuable paper validator. Unlike the complicated prior art design of using multiple light emitting diodes to scan different test zones of the test valuable paper and multiple optical elements to correct the light source output angle and an optical element to gather scanned light onto the photo sensor, the valuable paper validator of the invention has a simple structure that is inexpensive to manufacture and easy to install.

3. The valuable paper validator of the invention uses one single LED package to emit different wavelengths of intense pulsed light for scanning a predetermined area of the test valuable paper. The LED package has a small size, practical for use in a limited space in a vending machine or coin change machine. The valuable paper validator has a simple structure that does not require a precision radiation angle correction. Further, the valuable paper validator has the advantages of non-necessity of lamp warming time, fast reaction speed, small size, low power consumption, low pollution, high brightness and long working life. By means of the validation of the valuable paper validator of the present invention, valuable paper verification efficiency and accuracy are greatly improved.

4. The invention uses different wavelengths of intense pulsed light to provide different transmittance for verifying the authenticity of a valuable paper. By means of controlling the light emitting diode chips of the LED package to emit different wavelengths of intense pulsed light through the paper material, fluorescent fibers or ink of the test valuable paper, the invention achieves high verification accuracy.

5. The LED package can be made having multiple light emitting diode chips controllable to emit different colors of visible and invisible light at different wavelengths for verifying the authenticity of the test valuable paper, thereby achieving high verification accuracy.

6. By means of the security gate and the security hook, the invention effectively prohibits evil persons from using an iron wire or adhesive tape to pick up banknotes from the moneybox in the vending machine or coin change machine.

A prototype of valuable paper validator has been constructed with the features of FIGS. 1˜10. The valuable paper validator functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A valuable paper validator comprising:
a delivery unit for delivering a valuable paper to a validation unit for verifying the authenticity of the valuable paper, said delivery unit having a delivery path for the passing of a valuable paper for verification;
an optical emitter module arranged above said delivery path, said optical emitter module comprising a plurality of LED packages arranged in parallel, said LED packages each comprising a plurality of light emitting diode chips controllable to emit different wavelengths of intense pulsed light;
a plurality of first lenses set between said LED packages and said delivery path corresponding to said LED packages;
an optical receiver module arranged below said delivery path, said optical receiver module comprising a plurality of photodiodes corresponding to said first lenses and said LED packages and adapted to receive light passing from said LED packages through the valuable paper being delivered through said delivery path; and
a plurality of second lenses set between said delivery path and said photodiodes of said optical receiver module corresponding to said first lenses respectively.

2. The valuable paper validator as claimed in claim 1, wherein said LED packages each are controllable to emit different wavelengths of intense pulsed light through the associating first lens onto one same location at the valuable paper being delivered through said delivery path.

3. The valuable paper validator as claimed in claim 1, wherein said LED packages each are controllable to emit light through the associating first lens onto the valuable paper being delivered through said delivery path to form a respective test zone on the valuable paper.

4. The valuable paper validator as claimed in claim 1, wherein said LED packages, said first lenses, said second lenses and said photodiodes are respectively aligned on a respective axis.

5. The valuable paper validator as claimed in claim 1, wherein said light emitting diode chips of each of said LED packages include at least one light emitting diode chip adapted to emit a visible light and at least one light emitting diode chip adapted to emit an invisible light.

6. The valuable paper validator as claimed in claim 5, wherein said visible light is one of red light, green light and blue light.

7. The valuable paper validator as claimed in claim 5, wherein said invisible light is one of infrared light and ultraviolet light.

8. The valuable paper validator as claimed in claim 1, wherein the light received by each of said photodiode has the characteristic of different transmittance produced by means of radiation of different wavelengths of intense pulsed light from the associating LED package through the valuable paper being delivered through said delivery path.

9. The valuable paper validator as claimed in claim 1, wherein the light received by said photodiodes includes parallel light of different wavelengths of intense pulsed light emitted by said LED packages and filtered by color means of the valuable paper being delivered through said delivery path.

10. The valuable paper validator as claimed in claim 1, wherein said first lenses are collimator lenses.

11. The valuable paper validator as claimed in claim 1, wherein said second lenses are condensing lenses.

12. The valuable paper validator as claimed in claim 1, wherein said photodiodes are adapted to examine fluorescent fibers of the valuable paper being delivered through said delivery path when received parallel light passing through the valuable paper being delivered through said delivery path.

13. The valuable paper validator as claimed in claim 1, wherein said photodiodes are adapted to examine ink of the valuable paper being delivered through said delivery path when received parallel light passing through the valuable paper being delivered through said delivery path.

14. The valuable paper validator as claimed in claim 1, further comprising a security device.

15. The valuable paper validator as claimed in claim 1, which is usable in a vending machine and a coin change machine.

16. A valuable paper validator comprising:
a delivery unit for delivering a valuable paper to a validation unit for verifying the authenticity of the valuable paper, said delivery unit having a delivery path for the passing of a valuable paper for verification;
an optical emitter module arranged above said delivery path, said optical emitter module comprising a plurality of LED packages arranged in parallel, said LED packages each comprising a plurality of light emitting diode chips controllable to emit different wavelengths of intense pulsed light;
a plurality of first lenses set between said LED packages and said delivery path and respectively arranged in axial alignment with said LED packages;
an optical receiver module arranged below said delivery path, said optical receiver module comprising a plurality of photodiodes respectively arranged in axial alignment with said first lenses and said LED packages and adapted to receive light passing from said LED packages through valuable paper being delivered through said delivery path respectively; and
a plurality of second lens set between said delivery path and said photodiodes of said optical receiver module and arranged in axial alignment with said first lenses respectively.

17. The valuable paper validator as claimed in claim 16, wherein said LED packages each are controllable to emit different wavelengths of intense pulsed light through the associating first lens onto one same location at the valuable paper being delivered through said delivery path.

18. The valuable paper validator as claimed in claim 16, wherein said LED packages each are controllable to emit light through the associating first lens onto the valuable paper being delivered through said delivery path to form a respective test zone on the valuable paper.

19. The valuable paper validator as claimed in claim 18, wherein said test zone has a predetermined area and shape.

20. The valuable paper validator as claimed in claim 16, wherein said light emitting diode chips of each of said LED packages include at least one light emitting diode chip adapted to emit a visible light and at least one light emitting diode chip adapted to emit an invisible light.

21. The valuable paper validator as claimed in claim 20, wherein said visible light is one of red light, green light and blue light.

22. The valuable paper validator as claimed in claim 20, wherein said invisible light is one of infrared light and ultraviolet light.

23. The valuable paper validator as claimed in claim 16, wherein said first lenses are collimator lenses.

24. The valuable paper validator as claimed in claim 16, wherein said second lenses are condensing lenses.

25. The valuable paper validator as claimed in claim 16, further comprising a security gate at one side.

26. The valuable paper validator as claimed in claim 25, further comprising a security hook at one side of said security gate.

27. The valuable paper validator as claimed in claim 16, which is usable in a vending machine and a coin change machine.
